(19) United States
(12) Patent Application Publication
(10) Pub. No.: US 2024/0006664 A1
(43) Pub. Date: Jan. 4, 2024

(54) DUAL-ION BATTERY PERFORMANCE

(71) Applicant: LAWRENCE LIVERMORE NATIONAL SECURITY, LLC, Livermore, CA (US)

(72) Inventor: Steven A. Hawks, Livermore, CA (US)

(21) Appl. No.: 17/809,983

(22) Filed: Jun. 30, 2022

(51) Int. Cl. H01M 10/42; H01M 10/0566

(52) U.S. Cl. CPC H01M 10/4214; H01M 10/0566

(57) ABSTRACT

Energy storage apparatus, systems, and methods provide an energy storage enclosure, a negative electrode in the enclosure, a positive electrode in the enclosure, a separator between the negative electrode and the positive electrode, an electrolyte in the enclosure, and the circulation of the electrolyte through the negative electrode and the positive electrode.

### STATEMENT AS TO RIGHTS TO APPLICATIONS MADE UNDER FEDERALLY SPONSORED RESEARCH AND DEVELOPMENT

This invention was made with Government support under Contract No. DE-AC52-07NA27344 awarded by the United States Department of Energy. The Government has certain rights in the invention.

### BACKGROUND

### Field of Endeavor

The present application relates to batteries and more particularly to dual-ion batteries.

### State of Technology

This section provides background information related to the present disclosure which is not necessarily prior art.

Dual-ion batteries (DIBs) are of significant interest as low-cost alternatives to Li-ion batteries (LIB). DIBs can be constructed from low-cost electrode materials (e.g., Al foil and graphite) using Li-free electrolytes (e.g., K+/FSI− in ethylene carbonate/dimethyl carbonate) and have reached >200 Wh/kg at the cell level with cell voltages exceeding 5 V. The main issues with DIBs are that they require excessively concentrated electrolytes and/or overly thick separators to utilize the full capacity of the electrode materials and experience substantial volume changes in the electrolyte while charging and discharging due to the need to have both ions participate in energy storage. Because of these limitations, DIBs have not made a significant commercial impact. The apparatus, systems and methods described herein solves the main issues that plague DIBs by allowing the use of an optimized conductivity electrolyte, minimally thick separators, maximally thick electrode layers, and negligible volume changes upon charging and discharging.

### SUMMARY

Features and advantages of the disclosed apparatus, systems, and methods will become apparent from the following description. Applicant is providing this description, which includes drawings and examples of specific embodiments, to give a broad representation of the apparatus, systems, and methods. Various changes and modifications within the spirit and scope of the application will become apparent to those skilled in the art from this description and by practice of the apparatus, systems, and methods. The scope of the apparatus, systems, and methods is not intended to be limited to the particular forms disclosed and the application covers all modifications, equivalents, and alternatives falling within the spirit and scope of the apparatus, systems, and methods as defined by the claims.

Applicant's apparatus, systems, and methods provide an energy storage enclosure, a negative electrode in the enclosure, a positive electrode in the enclosure, a separator between the negative electrode and the positive electrode, an electrolyte in the enclosure, and the circulation of the electrolyte through the negative electrode and the positive electrode. Applicant's apparatus, systems, and methods have use in batteries, electrical energy storage, microbatteries, next-generation batteries, hybrid vehicles, electric vehicles, alternative energy, stationary energy storage, and other applications.

The apparatus, systems, and methods are susceptible to modifications and alternative forms. Specific embodiments are shown by way of example. It is to be understood that the apparatus, systems, and methods are not limited to the particular forms disclosed. The apparatus, systems, and methods cover all modifications, equivalents, and alternatives falling within the spirit and scope of the application as defined by the claims.

### BRIEF DESCRIPTION OF THE DRAWINGS

The accompanying drawings, which are incorporated into and constitute a part of the specification, illustrate specific embodiments of the apparatus, systems, and methods and, together with the general description given above, and the detailed description of the specific embodiments, serve to explain the principles of the apparatus, systems, and methods.

FIG. 1 is an illustrative view showing an energy storage device constructed in accordance with Applicant's apparatus, systems, and methods.

FIG. 2 is an illustrative view showing a battery constructed in accordance with Applicant's apparatus, systems, and methods.

FIG. 3 shows example data of the effect of flow on Applicant's energy storage device where HRT stands for the hydrolytic residence time.

### DETAILED DESCRIPTION OF SPECIFIC EMBODIMENTS

Referring to the drawings, to the following detailed description, and to incorporated materials, detailed information about the apparatus, systems, and methods is provided including the description of specific embodiments. The detailed description serves to explain the principles of the apparatus, systems, and methods. The apparatus, systems, and methods are susceptible to modifications and alternative forms. The application is not limited to the particular forms disclosed. The application covers all modifications, equivalents, and alternatives falling within the spirit and scope of the apparatus, systems, and methods as defined by the claims.

A dual ion battery is fundamentally different than a “normal” rechargeable battery in that both anion and cation are simultaneously stored (e.g., intercalated) during charging and then released (e.g., de-intercalated) during discharging. A “normal” rechargeable battery, for example, operates in a different, so-called rocking-chair format, where for example only Li+ ions, are de-intercalated from one electrode and simultaneously intercalated in the other during both charging and discharging operation. The unique ion storage mechanism of a DIB means that the electrolyte is desalinated during charging and resalinated during discharging, which can lead to a host of issues and limitations.

Applicant's apparatus, systems, and methods solve this issue and provide improved dual-ion battery performance. The applicant's apparatus, systems, and methods involve fabricating a device to allow electrolyte flow, therein creating what is called a “convection battery.” In this embodiment, electrolyte is introduced by forced convection from an external reservoir, rather than remaining sealed and stagnant within the cell. By decoupling the necessary amount of electrolyte from cell design, many of the inherent challenges of dual-ion batteries are circumvented. Namely, this idea allows for sufficient ions to participate in energy storage while not forcing the battery designer to use excessively concentrated electrolytes, employ overly thick separators, or experience substantial volume changes in the electrolyte while charging/discharging.

In the convection cell, electrolyte is pumped through porous electrodes to decrease diffusion or concentration overpotential losses and make the ion concentration and electrical potential in the electrolyte more uniform across the thickness of the cell. By substantially reducing diffusion limitations, thicker electrodes, higher specific capacity, and energy density can be achieved. Regarding the invention herein, adding electrolyte convection to a DIB is substantially more beneficial beyond these reasons because it alleviates the issue of significant volume changes in the electrolyte, allows for an optimal conductivity electrolyte concentration to be used, and frees the battery designer to use a cell design that is optimal to performance rather than large enough to accommodate sufficient ions. All these issues are resolved by simply making the electrolyte reservoir of sufficient size with sufficient flow rate.

Applicant anticipates that the performance gains by changing to this format will far outweigh the added electrolyte and pumping costs. Furthermore, there are many other benefits of having an external electrolyte reservoir system, especially in stationary storage applications.

Applicant's apparatus, systems, and methods have use in batteries, electrical energy storage, microbatteries, next-generation batteries, hybrid vehicles, electric vehicles, alternative energy, and stationary energy storage. This innovation could potentially unlock DIBs for widespread use as energy storage systems and has unprecedented potential to increase the performance of conventional and emerging battery technologies.

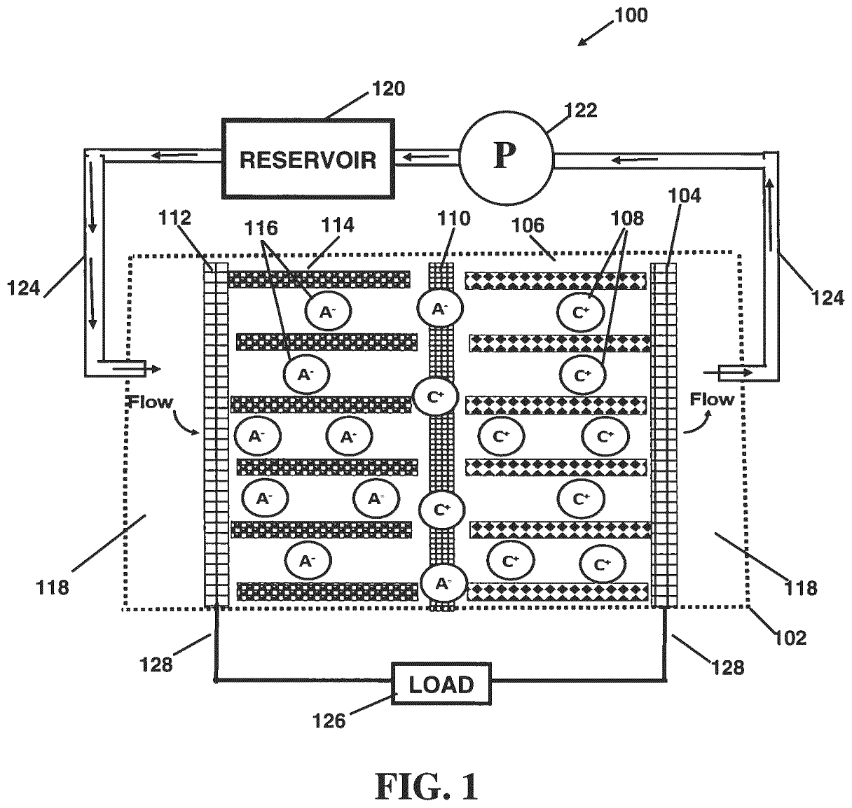

Referring now to the drawings and in particular to FIG. 1, an illustrative view shows an embodiment of Applicant's apparatus, systems, and methods. This embodiment is an energy storage device which is identified generally by the reference numeral 100. The components of Applicant's energy storage device 100 illustrated in FIG. 1 are listed below:
Reference Numeral No. 102—energy storage enclosure,
Reference Numeral No. 104—negative electrode current collector,
Reference Numeral No. 106—negative electrode,
Reference Numeral No. 108—intercalating anions in negative electrode chamber,
Reference Numeral No. 110—separator,
Reference Numeral No. 112—positive electrode current collector,
Reference Numeral No. 114—positive electrode,
Reference Numeral No. 116—intercalating anions in positive electrode chamber,
Reference Numeral No. 118—electrolyte,
Reference Numeral No. 120—reservoir,
Reference Numeral No. 122—pump,
Reference Numeral No. 124—electrolyte conduits,
Reference Numeral No. 126—load, and
Reference Numeral No. 128—electrical connections.

The description of the structural components of the Applicants' apparatus, systems, and methods 100 having been completed, the operation and additional description of the Applicant's apparatus, systems, and methods will now be considered in greater detail.

FIG. 1 illustrates an energy storage enclosure 102, a negative electrode 106 in said enclosure with intercalating anions capability, a positive electrode 114 in said enclosure with intercalating anions capability, a separator 110 between said negative electrode and said positive electrode, and an electrolyte 118 in said enclosure. A pump 122 circulates the electrolyte 118 through the energy storage enclosure 102.

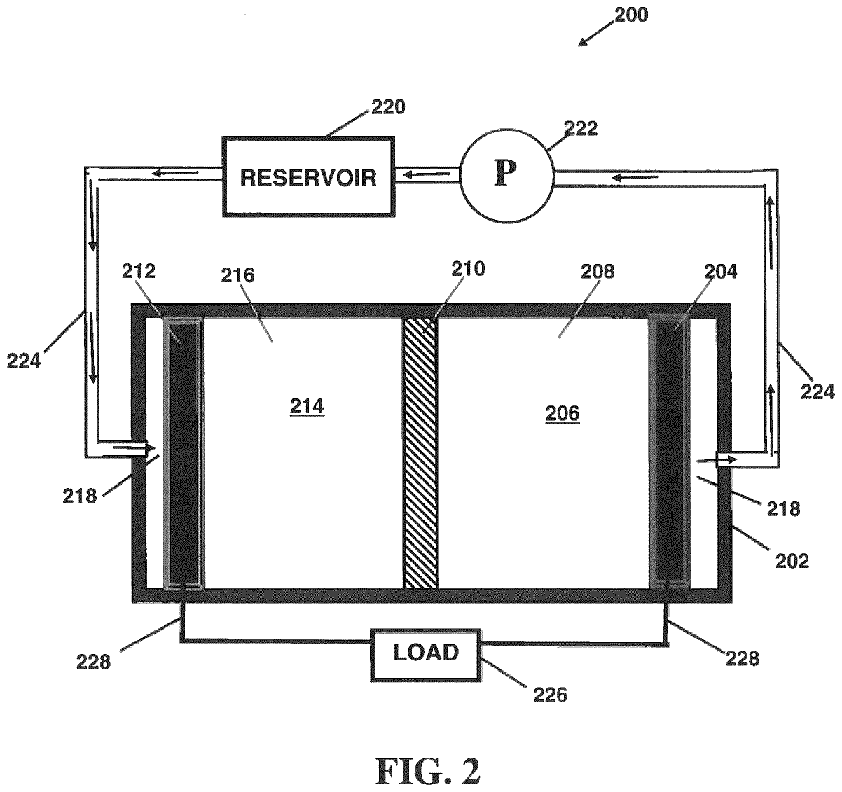

Referring now to FIG. 2, an illustrative view shows another embodiment of Applicant's apparatus, systems, and methods. This embodiment is identified generally by the reference numeral 200. The components of Applicant's apparatus, systems, and methods 200 illustrated in FIG. 2 are listed below:
Reference Numeral No. 202—battery enclosure,
Reference Numeral No. 204—negative electrode current collector,
Reference Numeral No. 206—negative electrode,
Reference Numeral No. 208—intercalating anions in negative electrode chamber,
Reference Numeral No. 210—separator,
Reference Numeral No. 212—positive electrode current collector,
Reference Numeral No. 214—positive electrode,
Reference Numeral No. 216—intercalating anions in positive electrode chamber,
Reference Numeral No. 218—electrolyte,
Reference Numeral No. 220—reservoir,
Reference Numeral No. 222—pump,
Reference Numeral No. 224—electrolyte conduits,
Reference Numeral No. 226—load, and
Reference Numeral No. 228—electrical connections.

The description of the structural components of the Applicants' apparatus, systems, and methods 200 having been completed, the operation and additional description of the Applicant's apparatus, systems, and methods will now be considered in greater detail.

FIG. 2 illustrates a battery enclosure 202, a negative electrode 206 in said enclosure with intercalating anions capability, a positive electrode 214 in said enclosure with intercalating anions capability, a separator 210 between said negative electrode and said positive electrode, and an electrolyte 218 in said enclosure. A pump 222 circulates the electrolyte 218 through the battery enclosure 202.

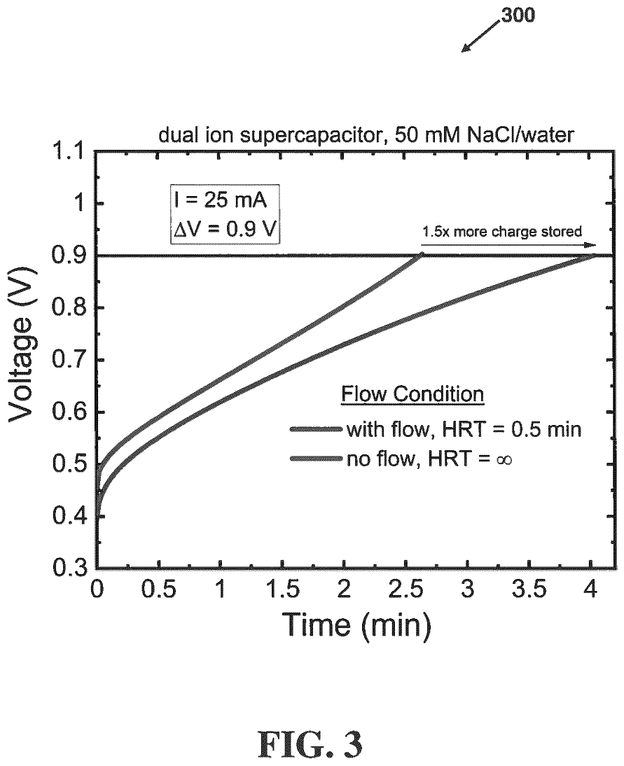

Referring now to FIG. 3, an illustration shows example data of the effect of flow on a dual ion energy storage device. This illustration is identified generally by the reference numeral 300. The illustration 300 demonstrates a 1.5× enhancement in capacity at ˜20 C rate charging when the hydraulic residence time (HRT) is made finite

Although the description above contains many details and specifics, these should not be construed as limiting the scope of the application but as merely providing illustrations of some of the presently preferred embodiments of the apparatus, systems, and methods. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present application fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present apparatus, systems, and methods, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

While the apparatus, systems, and methods may be susceptible to various modifications and alternative forms, specific embodiments have been shown by way of example in the drawings and have been described in detail herein. However, it should be understood that the application is not intended to be limited to the particular forms disclosed. Rather, the application is to cover all modifications, equivalents, and alternatives falling within the spirit and scope of the application as defined by the following appended claims.

1. An energy storage apparatus, comprising:
an energy storage enclosure,
a negative electrode in said enclosure,
a positive electrode in said enclosure,
a separator between said negative electrode and said positive electrode,
an electrolyte in said enclosure,
a conduit connected to said electrolyte in said enclosure proximate said negative electrode and connected to said electrolyte proximate said positive electrode, and
a pump connected to said conduit for circulating said electrolyte.

2. The energy storage apparatus of claim 1 including stored cations in said negative electrode and stored anions in said positive electrode.

3. The energy storage apparatus of claim 1 including stored cations in said negative electrode and stored anions in said positive electrode.

4. The energy storage apparatus of claim 1 including stored cations in said negative electrode and stored anions in said positive electrode.

5. The energy storage apparatus of claim 1 including a negative electrode current collector in said enclosure.

6. The energy storage apparatus of claim 1 including a positive electrode current collector in said enclosure.

7. The energy storage apparatus of claim 1 wherein said electrolyte is a liquid electrolyte.

8. The energy storage apparatus of claim 1 further comprising an electrolyte reservoir connected to said conduit.

9. A battery apparatus, comprising:
a battery enclosure,
a negative electrode in said battery enclosure,
a positive electrode in said battery enclosure,
a separator between said negative electrode and said positive electrode,
an electrolyte in said battery enclosure,
a conduit connected to said electrolyte in said battery enclosure proximate said negative electrode and connected to said electrolyte proximate said positive electrode, and
a pump connected to said conduit for circulating said electrolyte.

10. The battery apparatus of claim 9 including stored cations in said negative electrode and stored anions in said positive electrode.

11. The battery apparatus of claim 9 including stored cations in said negative electrode and stored anions in said positive electrode.

12. The battery apparatus of claim 9 including stored cations in said negative electrode and stored anions in said positive electrode.

13. The battery apparatus of claim 9 including a negative electrode current collector in said battery enclosure.

14. The battery apparatus of claim 9 including a positive electrode current collector in said battery enclosure.

15. The battery apparatus of claim 9 wherein said electrolyte is a liquid electrolyte.

16. The battery apparatus of claim 9 further comprising an electrolyte reservoir connected to said conduit.

17. An energy storage method, comprising the steps of:
providing an energy storage enclosure,
providing a negative electrode in said enclosure,
providing a positive electrode in said enclosure,
providing a separator between said negative electrode and said positive electrode,
providing an electrolyte in said enclosure, and
circulating said electrolyte through said negative electrode and said positive electrode.

18. The energy storage method of claim 17 wherein said negative electrode stores cations.

19. The energy storage method of claim 17 wherein said positive electrode stores anions.

20. The energy storage method of claim 17 wherein said negative electrode stores cations and positive electrode stores anions.

21. The energy storage method of claim 17 including the step of providing a negative electrode current collector in said enclosure.

22. The energy storage method of claim 17 including the step of providing a positive electrode current collector in said enclosure.

23. The energy storage method of claim 17 wherein said electrolyte is a liquid electrolyte.

24. The energy storage method of claim 17 further comprising the step of providing an electrolyte reservoir connected to said conduit.
